(19) United States
(12) Patent Application Publication
(10) Pub. No.: US 2007/0115936 A1
(43) Pub. Date: May 24, 2007

(54) Updating status of feature services in universal messaging

(76) Inventor: Gregory P. Newton, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/305,635

(22) Filed: Dec. 16, 2005

Related U.S. Application Data
(60) Provisional application No. 60/722,459, filed on Sep. 30, 2005.

(51) Int. Cl. H04M 1/64; H04L 12/66

(52) U.S. Cl. 370/352; 379/88.12

(57) ABSTRACT

Embodiments of the present disclosure provide systems and methods for relaying status information between messaging systems. Briefly described, one embodiment of the system, among others, includes a monitoring system for detecting a change in state of one or more messages maintained on a database for a user, where the database is accessible by at least a first messaging system and a second messaging system; and a notification system for notifying the second messaging system of a change in state of the one or more messages when the change is caused from an access of the one or more messages by the second messaging system. Other systems and methods are also provided.

### CROSS-REFERENCE TO RELATED APPLICATION

This application claims priority to U.S. provisional application entitled, “UPDATING STATUS OF FEATURE SERVICES IN UNIVERSAL MESSAGING,” having Ser. No. 60/722,459, filed Sep. 30, 2005, which is entirely incorporated herein by reference.

### TECHNICAL FIELD

The present disclosure is generally related to messaging systems and, more particularly, is related to sharing information between messaging systems.

### BACKGROUND

Consider that in some universal messaging schemes, different messaging systems utilize the same storage systems and access the same messages. For example, a voicemail messaging system may store voicemail messages in a storage system that is also used to store e-mail messages. Further, the voicemail messages may be accessible by the voicemail system and also an e-mail system. Each messaging system may maintain status information on the current state of messages being maintained on the storage system for a user. For example, an e-mail messaging system may maintain a count of how many messages on a storage system have been read and how many have been unread by the user. Further, a voicemail system may maintain a count of how many voicemail messages have been reviewed and have not been reviewed by a user. Therefore, when a user reads a message with the e-mail messaging system, the voicemail system may not be aware that the message count is no longer valid. Similar problems also exist if other messaging systems access and/or monitor the status of the messages stored on the storage system.

Thus, a heretofore unaddressed need exists in the industry to address the aforementioned deficiencies and inadequacies.

### SUMMARY

Embodiments of the present disclosure provide systems and methods for relaying status information between messaging systems. Briefly described, one embodiment of the system, among others, includes a monitoring system for detecting a change in state of one or more messages maintained on a database for a user, where the database is accessible by at least a first messaging system and a second messaging system; and a notification system for notifying the second messaging system of a change in state of the one or more messages when the change is caused from an access of the one or more messages by the second messaging system.

Embodiments of the present disclosure can also be viewed as providing methods for relaying status information between messaging systems. In this regard, one embodiment of such a method, among others, can be broadly summarized by the following steps: detecting a change in state of one or more messages of a user, the change in state being caused by the one or more messages being accessed by a first messaging system; and relaying the change in state to a second messaging system that is also configured to access the one or more messages, such that the second messaging system updates a status of the messages to correspond to a status maintained by the first messaging system for the one or more messages

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of a universal messaging system in accordance with the present disclosure.

FIG. 2 is a flow diagram representing interactions within one embodiment of the system of FIG. 1.

FIG. 3 is a flow diagram representing interactions within one embodiment of the system of FIG. 1.

FIG. 4 is a flow diagram representing interactions within one embodiment of the system of FIG. 1.

FIG. 5 is a flow chart of one embodiment of a method for relaying status information between messaging systems of FIG. 1.

### DETAILED DESCRIPTION

In a universal messaging scheme, a problem may arise where one messaging system is unaware of the actions of other messaging systems which results in the state of the messages becoming out of sync between the respective systems. For example, if a user receives a new voicemail message that is promptly reviewed by a user via an e-mail application, the e-mail system may have an accurate message count (in that there are no unread messages) while the voicemail system may have an inaccurate message count (in that it has not been notified that the new voicemail message has been read using the e-mail system).

Therefore, solutions to the aforementioned problem are discussed with respect to voicemail and e-mail systems, although the solution is generally applicable to any two (or more) messaging systems and is not intended to be limited to the examples provided.

For example, consider that voicemails are often stored in an e-mail store and may be accessed by both a VoIP (voice over Internet protocol) telephone and an e-mail client. Therefore, one common scenario is where the following events occur: a call is received by a voicemail system, a voicemail message is recorded, the voicemail message is stored in the e-mail store, and the voicemail system triggers an indicator light of the VoIP telephone to be activated in order to alert a user of a new voicemail message.

However, if the user reviews the voicemail message via his or her e-mail client, the indicator light on the VoIP telephone remains on, and a user will naturally think he or she has another new voicemail message (unless the voicemail system is somehow notified to deactivate the indicator light).

The inverse of this situation may also be true. For example, a user may first listen to a voicemail message over a VoIP telephone, and then later mark the message as being unread utilizing his or her e-mail client, with the intent that another user is alerted about the voicemail message. However, in conventional systems, there is no mechanism for relaying a change in status information from an e-mail server that is maintaining an e-mail store to a VoIP telephone such that the indicator light may be reactivated.

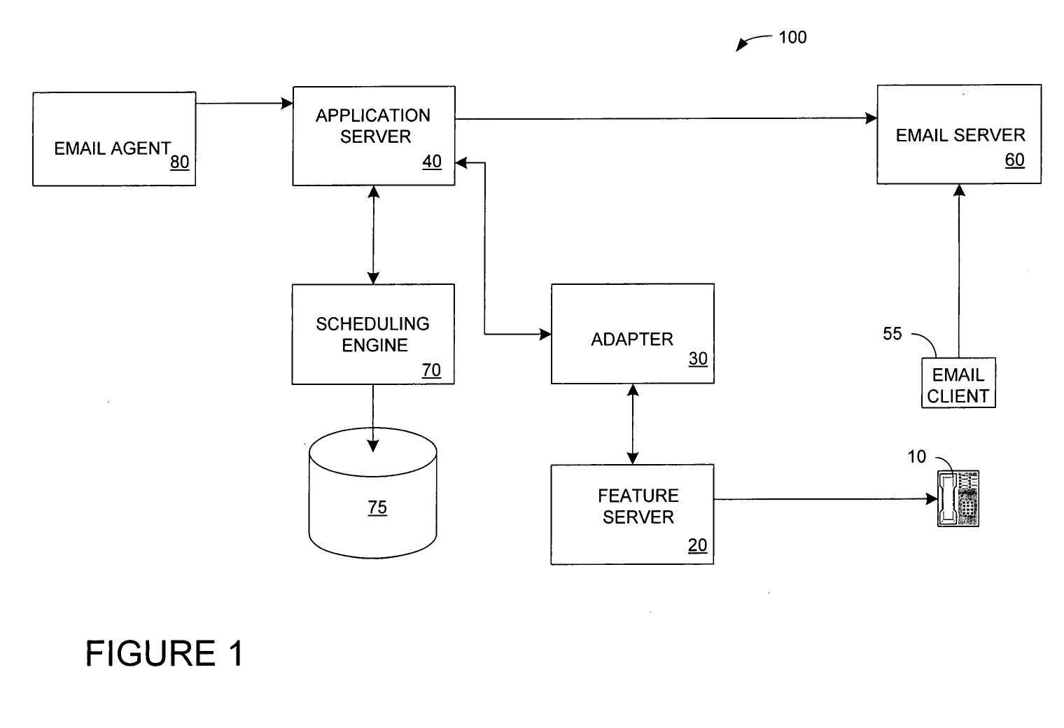

Accordingly, FIG. 1 is a block diagram of one embodiment of a universal messaging system 100 in accordance with the present disclosure. As shown, customer premise equipment 10 (e.g., a VoIP phone) is provided. It should be appreciated that the customer premises equipment 10 is not limited to a VoIP phone but may be any communications device. The customer premise equipment communicates with a feature server 20 that enables the customer premise equipment to execute various communication features, such as, but not limited to: triggering a display or indicator light to activate when a new voicemail message is detected; activating a stutter tone as a message waiting indicator; providing an updated message count to the customer premises equipment so that a message display may be updated, etc. In one embodiment, communications between the customer premise equipment 10 and the feature server 20 utilize a Session Initiation Protocol (SIP).

Since other components of the system communicate utilizing different communication protocols, an adapter application 30 is provided to format communications from one protocol to another. For example, in one embodiment the adapter application 30 formats communications in a SIP protocol (e.g., from the feature server 20) into communications in a SOAP (Simple Object Access Protocol) protocol that is utilized by an application server 40.

In one embodiment, application server 40 is designed to support interoperable machine-to-machine interaction over a network. Other system components interact with the application server 40 utilizing messages, which may be enclosed in a variety of communication protocols. Accordingly, the application server 40 is configured to communicate with different system components, such as the adapter application 30, scheduling engine 50, custom e-mail agent 80, and e-mail server 60.

The e-mail server 60 maintains an e-mail store (not shown) for users of the e-mail server, which may include voicemail messages, and other forms of electronic messaging. The e-mail server 60 communicates with the application server 40 utilizing an IMAP (Internet Message Access Protocol) communications standard, in one embodiment. Utilizing an e-mail client 55, a user may request his or her e-mail messages from the e-mail server 60.

Accordingly, in an exemplary embodiment, the application server 40 is notified of a change in state with regard to a user's voicemail messages that are maintained by the e-mail server 60. As a result, the application server 40 causes the feature server 20 to update the status with the customer premise equipment 10, so that the state of the voicemail messages as reflected by the customer premise equipment 10 is consistent with the state of the voicemail messages as maintained by the e-mail server 60.

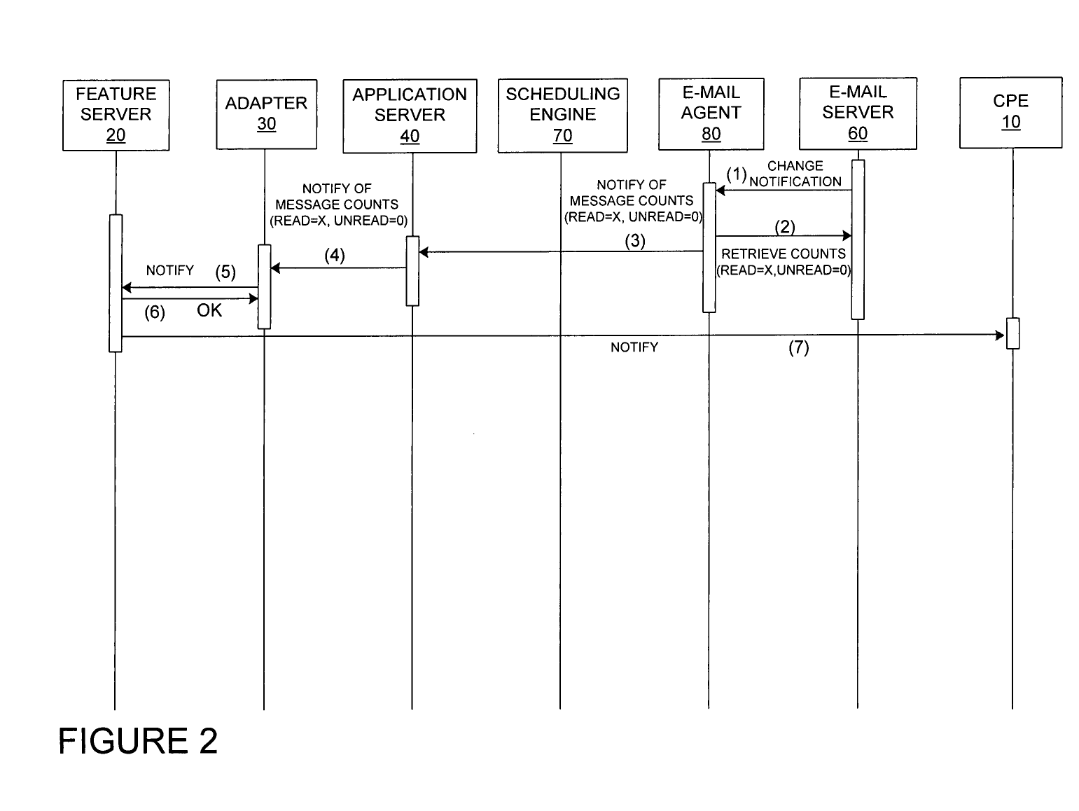

Referring now to FIG. 2, a flow diagram representing one embodiment of the present disclosure is shown. In this embodiment, the e-mail agent 80 is used to notify the application server 40 of a change in state with regard to voicemail messages maintained by the e-mail server 60. The e-mail agent 80 is a software component that is configured to receive updates about events from the e-mail server 60. For example, the e-mail server 60 may be configured to notify (1) the e-mail agent 80 about changes in state of a user's voicemail messages, such as a change in message count. The e-mail agent 80 then retrieves (2) the current message count (e.g., X messages read & 0 unread messages) from the e-mail server 80, via a shared API (application programming interface).

The e-mail agent 80 then relays (3) the information to the application server 40. The application server 40 communicates the updated message count to the feature server 20. In some embodiments, the application server 40 may utilize an adapter application 30 to facilitate transmission to the application server 40, such that the application server communicates (4) the information to the adapter application 30 in one communication protocol that is then relayed (5) to the feature server 20 utilizing another protocol or standard, such as a Notify message under the SIP standard, which is one standard for communicating with VoIP equipment.

Accordingly, after receiving the message count update from the adapter application 30, the feature server 20 acknowledges (6) receipt and sends the updated message count to the customer premise equipment (CPE) 10 (e.g., in the form of a Notify message) so that the CPE may reflect the current message count state of voicemail messages and adjust any related settings, as applicable.

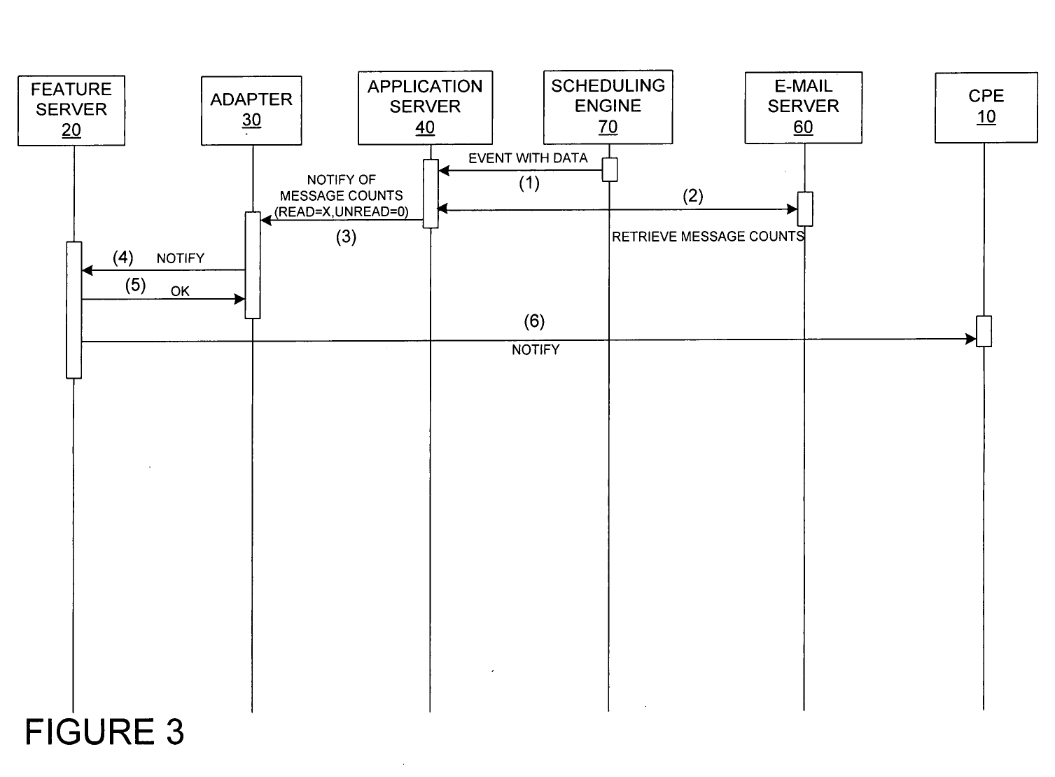

Referring now to FIG. 3, a flow diagram representing one embodiment of the present disclosure is shown. In this embodiment, the schedule engine 70 is used to notify the application server 40 of a change in state with regard to voicemail messages maintained by the e-mail server 60.

The scheduling engine 70 is set to periodically check the state of voicemail messages maintained on the e-mail server 60 and to relay the state to the feature server 20, so that a customer premise equipment 10 may reflect the current state. The scheduling engine 70 communicates with a database 75 that maintains settings for when the schedule engine 70 should check a state of a user's voicemail messages. For example, the settings may indicate that the scheduling engine 70 is to check every two minutes the state of a user's voicemail messages. Therefore, every two minutes, the scheduling engine generates (1) an event for the application server 40 with related data (e.g., user information). In response, the application server 40 retrieves (2) the current state of the user's voicemail messages and relays (3) the information to the adapter application 30. The adapter application 30 reformats the information in a protocol accepted by the feature server 20 and sends (4) the information to the feature server 20. The feature server 20 acknowledges (5) receipt and also forwards (6) the current state of the voicemail messages to the CPE 10, which may then make any adjustments necessary to reflect the current state of the voicemail messages for a particular user and to ensure that the CPE 10 is in sync with an e-mail server 60.

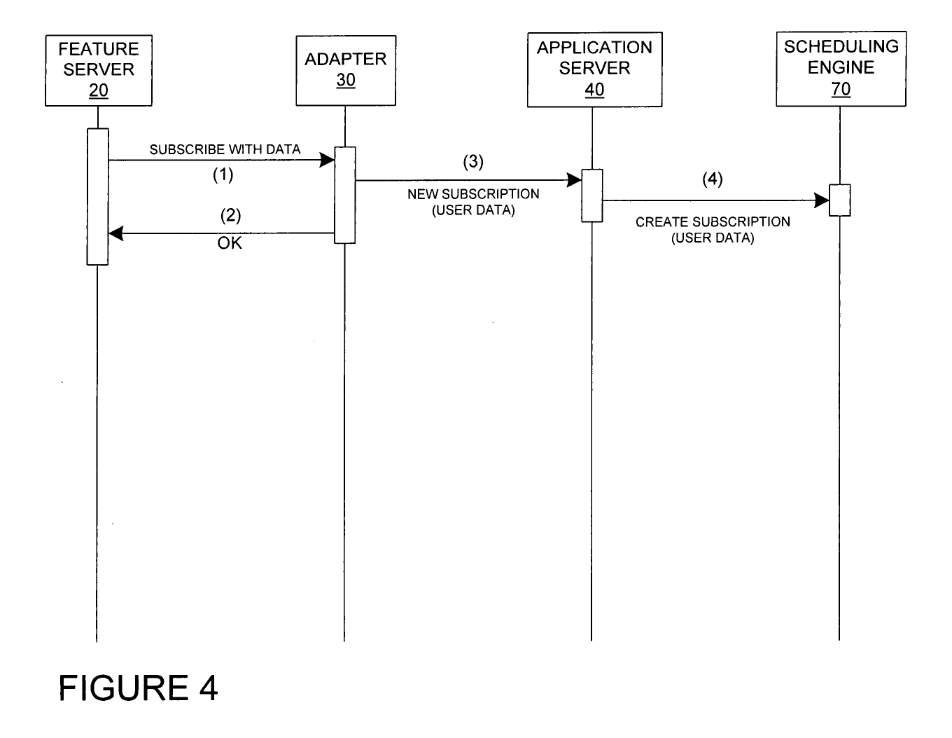

Referring now to FIG. 4, one embodiment of a process for generating a scheduling event is described. In this process, the feature server 20 sends (1) a request for a scheduling record or subscription along with applicable information to the adapter application 30. For example, data accompanying the subscription may include customer information, such as name, e-mail account, password information, and timing information indicating when a voicemail message count is to be checked. The adapter application 30 acknowledges (2) receipt and forwards (3) the information to the application server 40, which communicates (4) with the scheduling engine (70) so that the scheduling event can be created.

Note that in some embodiments, the scheduling operation and the e-mail agent operation may be utilized in the same system and both operations may be used to notify the application server 40 of a change in state.

With notification of a state change, a CPE 10 can adjust settings or operations based upon the current state, such as indicator lights, stutter tone indicators, display counts, automatic notification messages that are sent to notify users of state changes, etc.

Advantageously, in one embodiment, an exemplary universal messaging system 100 solves a problem that arises when a standard e-mail server is used to store voicemail messages. For example, when a voicemail is left for a subscriber, the voicemail system that records and deposits the voicemail knows that there is a new message and therefore can cause message waiting indicators (e.g. stutter tone) to be turned on the subscriber's telephone. One way this happens is when a subscriber calls into the voicemail application and listens to or deletes the new messages. As a result, the system knows that there are no new messages and can therefore turn MWI off.

However, in some systems, if the user or subscriber has access to that e-mail system that bypasses the voicemail application (e.g. they use an e-mail client application to retrieve their messages), then it is possible for the subscriber to listen to the message but to not have their MWI turned off. In this case, the e-mail store and the voicemail application are out of sync and the subscriber is presented with a false positive.

With an exemplary embodiment of the universal messaging system 100, the universal messaging system 100 periodically or continuously monitors the e-mail server on behalf of the subscriber and notices when the number of new voicemails changes. Accordingly, the voicemail server that controls the MWI is notified of the new message count so that it can turn the indicator off.

In some embodiments, a custom developed agent may also be installed on the e-mail server to detect a change in message status and proactively notify the voicemail server that the status has changed.

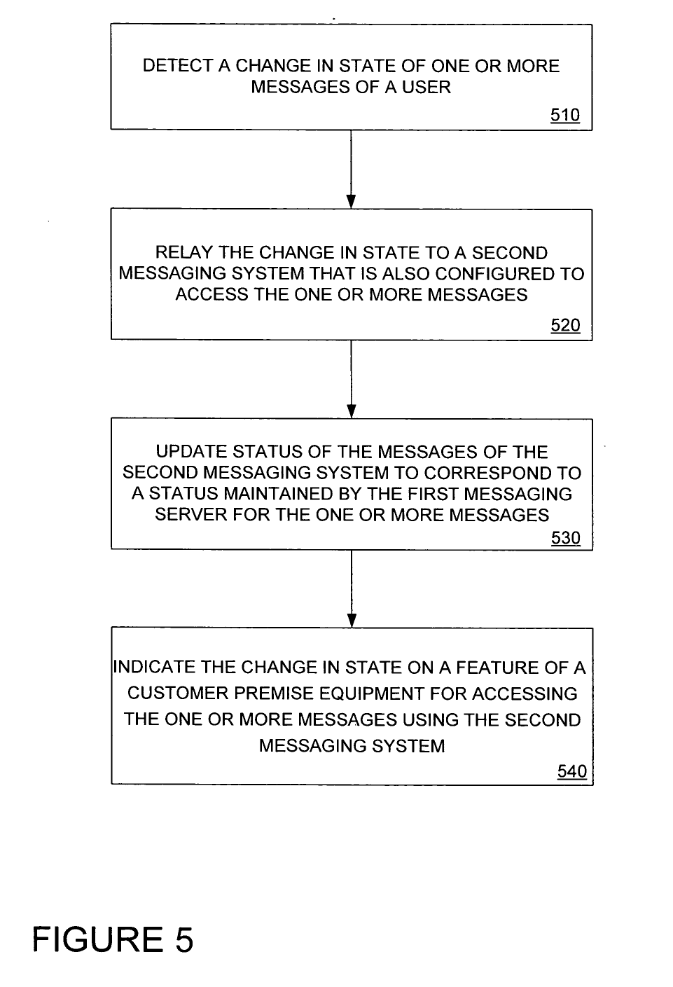

Referring now to FIG. 5, a flow chart of one embodiment of a method for relaying status information between messaging systems is presented. As shown, the method includes the step of detecting (510) a change in state of one or more messages of a user. For example, the change in state may be caused by the one or more messages being accessed by a first messaging system (e.g., a voicemail system, an e-mail system, an instant messaging system, etc.). Then, the change in state is relayed (520) to a second messaging system (e.g., an e-mail system, an instant messaging system, a voicemail system, etc.) that is also configured to access the one or more messages. Accordingly, the second messaging system updates (530) its status of the messages to correspond to a status maintained by the first messaging server for the one or more messages. Further, the change in state is indicated (540) on a feature of a customer premise equipment for accessing the one or more messages using the second messaging system.

Embodiments of the present disclosure can be implemented in hardware, software, firmware, or a combination thereof. In some embodiments, system components are implemented in software or firmware that is stored in a memory and that is executed by a suitable instruction execution system. If implemented in hardware, as in an alternative embodiment, the system components can be implemented with any or a combination of the following technologies, which are all well known in the art: a discrete logic circuit(s) having logic gates for implementing logic finctions upon data signals, an application specific integrated circuit (ASIC) having appropriate combinational logic gates, a programmable gate array(s) (PGA), a field programmable gate array (FPGA), etc.

Any process descriptions or blocks in flow charts or flow diagrams should be understood as representing modules, segments, or portions of code which include one or more executable instructions for implementing specific logical functions or steps in the process, and alternate implementations are included within the scope of the disclosure in which functions may be executed out of order from that shown or discussed, including substantially concurrently or in reverse order, depending on the functionality involved, as would be understood by those reasonably skilled in the art of the present disclosure.

System component logic may comprise an ordered listing of executable instructions for implementing logical functions and may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, commnunicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of embodiments in logic embodied in hardware or software-configured mediums.

It should be emphasized that the above-described embodiments of the present disclosure are merely possible examples of implementations, merely set forth for a clear understanding of the principles of the disclosure. Many variations and modifications may be made to the above-described embodiments without departing substantially from the spirit and principles of the disclosure. For example, although the embodiments above describe email and voicemail messaging systems for illustrative purposes, it should be appreciated that the invention is not limited to these types of messaging systems but may be applicable to any type of messaging system. All such modifications and variations are intended to be included herein within the scope of this disclosure.

1. A method for relaying status information between messaging systems, comprising:
detecting a change in state of one or more messages of a user, the change in state being caused by the one or more messages being accessed by a first messaging system; and
relaying the change in state to a second messaging system that is also configured to access the one or more messages, such that the second messaging system updates a status of the messages to correspond to a status maintained by the first messaging system for the one or more messages.

2. The method of claim 1, further comprising:
indicating the change in state on a feature of a customer premise equipment for accessing the one or more messages using the second messaging system.

3. The method of claim 1, the detecting step comprising:
periodically checking for a change in state of the one or more messages of the user.

4. The method of claim 1, further comprising:
sending out a notification message to the user with the status of the one or more messages after detecting the change in state.

5. The method of claim 1, wherein the first messaging system comprises an e-mail system and the second messaging system comprises a voicemail system.

6. The method of claim 2, wherein the customer premises equipment comprises a VoIP telephone and the feature comprises at least one of an indicator light and a stutter tone.

7. The method of claim 2, wherein the customer premises equipment comprises an e-mail client application.

8. A computer-readable medium having a program for relaying status information between messaging systems, the program having instructions for performing the steps of:
detecting a change in state of one or more messages of a user, the change in state being caused by the one or more messages being accessed by a first messaging system; and
relaying the change in state to a second messaging system that is also configured to access the one or more messages, such that the second messaging system updates a status of the messages to correspond to a status maintained by the first messaging system for the one or more messages.

9. The computer-readable medium of claim 8, the program further performing the step of:
indicating the change in state on a feature of a customer premise equipment for accessing the one or more messages using the second messaging system.

10. The computer-readable medium of claim 8, the detecting step further comprising:
periodically checking for a change in state of the one or more messages of the user.

11. The computer-readable medium of claim 8, the program further performing the step of:
sending out a notification message to the user with the status of the one or more messages after detecting the change in state.

12. The computer-readable medium of claim 8, wherein the first messaging system comprises an e-mail system and the second messaging system comprises a voicemail system.

13. The computer-readable medium of claim 9, wherein the customer premises equipment comprises a VoIP telephone and the feature comprises at least one of an indicator light and a stutter tone.

14. The computer-readable medium of claim 9, wherein the customer premises equipment comprises an e-mail client application.

15. A universal messaging system, comprising:
a monitoring system for detecting a change in state of one or more messages maintained on a database for a user, the database being accessible by at least a first messaging system and a second messaging system; and
a notification system for notifying the second messaging system of a change in state of the one or more messages when the change is caused from an access of the one or more messages by the second messaging system.

16. The universal messaging system of claim 15, wherein the second messaging updates its message status of the one or more messages to reflect the change in state caused by the access of the one or more messages by the first messaging system.

17. The universal messaging system of claim 15, further comprising:
a customer premise equipment that interacts with the second messaging system, wherein the customer premise equipment contains a feature for indicating a current message status and the customer premise equipment is relayed the change in state from the second messaging system.

18. The universal messaging system of claim 15, wherein the first messaging system operates under a different messaging protocol than the second messaging system.

19. The universal messaging system of claim 15, wherein the first messaging system is an e-mail system and the second messaging system is a voicemail system.

20. The universal messaging system of claim 17, wherein the feature comprises at least one of an indicator light, a stutter tone, and a visible indication within a messaging interface of a graphical user interface.
